(19) United States
(12) Patent Application Publication
(10) Pub. No.: US 2016/0217254 A1
(43) Pub. Date: Jul. 28, 2016

(54) IMAGE INSERTION INTO AN ELECTRONIC HEALTH RECORD

(71) Applicant: Practice Fusion, Inc., San Francisco, CA (US)

(72) Inventor: Matthew Christopher DOUGLASS, San Francisco, CA (US)

(21) Appl. No.: 14/606,731

(22) Filed: Jan. 27, 2015

(51) Int. Cl. G06F 19/00; H04L 29/06

(52) U.S. Cl. CPC G06F 19/321; G06F 19/322; H04L 63/0428

(57) ABSTRACT

The HIPAA Security Rule introduces problems that are solved by technical solutions including minimizing transactions among devices, reducing the number of times and places a captured image is stored, and transforming image data. Embodiments allow a user (e.g., a healthcare provider such as a physician or nurse) to use a computing device (e.g., a smart phone, a tablet, a personal digital assistant (PDA), or a personal computer) to capture an image and/or add an image (e.g., a photo of a rash), encrypt the image, transmit the encrypted image, decrypt the encrypted image, and insert the image directly into a patient medical data record while maintaining HIPAA Security Rule compliance. In embodiments, the selection of the patient medical data record may be based on a search of a user's patient list or the user's electronic appointment schedule that may be integrated into a workflow of the user's practice.

### BACKGROUND

1. Field

This field is generally related to adding an image to an electronic health record.

2. Background

### Electronic Health Records

Medical records related to a patient's health information are essential to the practice of medical care. Traditionally, medical records were paper-based documents. The emergence of electronic medical records (EMRs), which are a digital version of the paper chart that contains all of a patient's medical history from one medical practice, offers medical professionals and patients with new functionalities and efficiencies that paper-based medical records cannot provide. An EMR which can be incorporated into an electronic health record (EHR), is a collection of electronically stored information about an individual patient's medical history. EHRs may contain a broad range of data, including demographics, medical history, medication history, allergies, immunization records, laboratory test results, radiology images, vital signs, personal statistics like age and weight, and billing information. Many commercial EHR systems combine data from a number of healthcare services and providers, such as clinical care facilities, laboratories, radiology centers, and pharmacies.

EHRs are a drastic improvement over paper-based medical records. Paper-based medical records require a large amount of physical storage space. Paper records are often stored in different locations, and different medical professionals may each have different and incomplete records about the same patient. Obtaining paper records from multiple locations for review by a healthcare provider can be time consuming, complicated, and sometimes impossible. In contrast, EHR data is stored in digital format, and thus are more secure and can be accessed from anywhere. EHR systems significantly simplify the reviewing process for healthcare providers. Because records in EHRs can be linked together, EHRs vastly improve the accessibility of health records and the coordination of medical care.

EHRs also decrease the risk of misreading errors by healthcare professionals. Poor legibility is often associated with handwritten, paper medical records, which can lead to medical errors. EHRs, on the other hand, are inherently legible given that they are typically stored in typeface. In addition, EHRs enhance the standardization of forms, terminology and abbreviations, and data input, which help ensure reliability of medical records, and standardization of codesets and storage of EHR data means that data from different technical information systems can be displayed in a single, unified record. Further, EHRs can be transferred electronically, thus reducing delays and errors in recording prescriptions or communicating laboratory test results.

The benefits of digitizing health records are substantial. Healthcare providers with EHR systems have reported better outcomes, fewer complications, lower costs, and fewer malpractice claim payments. But despite EHRs' potential in drastically improving the quality of medical care, only a low percentage of healthcare providers use EHR systems. While the advantages of EHRs are significant, they also carry concerns, including high costs, lost productivity during EHR system implementation or computer downtime, and lack of EHR usability.

The Health Insurance Portability and Accountability Act (HIPAA), enacted in the U.S. in 1996, and as amended, established rules for use and access of protected health information (PHI). HIPAA provides restrictions on disclosure of and access to protected health information to and by third parties. HIPAA applies to information in electronic medical records, such as health information doctors and nurses input, documented conversations between a doctor and a patient, and information use to process or facilitate medical billing claims and documents. The HIPAA Security Rule, effective on Apr. 20, 2005 for most covered entities, adds additional constraints to electronic data security and the storage and transmission of PHI.

The high cost of EHR systems also significantly hinders EHR adoption. A large number of physicians without EHR systems have referred to initial capital costs as a barrier to adopting EHR systems. Cost concerns are even more severe in smaller healthcare settings, because current EHR systems are more likely to provide cost savings for large integrated institutions than for small physician offices. During the EHR system technology's setup and implementation process, productivity loss can further offset efficiency gains. The need to increase the size of information technology staff to maintain the system adds even more costs to EHR system usages.

Usability is another major factor that holds back adoption of EHR systems. It is particularly challenging to develop user-friendly EHR systems. There is a wide range of data that needs to be integrated and connected. Complex information and analysis needs vary from setting to setting, among healthcare provider groups, and from function to function within a healthcare provider group. To some providers, using electronic medical records can be tedious and time consuming, and the complexity of some EHR systems renders the EHR usage less helpful. Some doctors and nurses also complain about the difficulty and the length of time to enter patients' health information into the system.

Under-utilization of EHR systems, despite incentives and mandates from the government and the tremendous potential of EHR systems in revolutionizing the healthcare system, calls for better EHR systems that are secure, cost-effective, efficient, and user-friendly.

Comprehensive EHR systems can provide capabilities far beyond simply storing patients' medical records. Because EHR systems offer healthcare providers and their workforce members the ability to securely store and utilize structured health information, EHR systems can have a profound impact on the quality of the healthcare system. In Framework for Strategic Action on Health Information Technology, published on Jul. 21, 2004, the Department of Health & Human Services (HHS) outlined many purposes for EHR services. The outlined purposes include, among other things, improving healthcare outcomes and reducing costs, reducing recordkeeping and duplication burdens, improving resource utilization, care coordination, active quality and health status monitoring, reducing treatment variability, and promoting patients' engagement in and ownership over their own healthcare.

Recent legislation has set goals and committed significant resources for health information technology (IT). One of the many initiatives of the American Recovery and Reinvestment Act of 2009 (ARRA) was “to increase economic efficiency by spurring technological advances in science and health.” The Health Information Technology for Economic and Clinical Health (HITECH) Act, passed as a part of ARRA, allocated billions of dollars for healthcare providers to adopt and meaningfully use EHR systems in their practices. HITECH also mandates the Office of the National Coordinator for Health Information Technology (ONC) to define certification criteria for “Certified EHR Technology.”

EHR systems satisfying “Certified EHR Technology” criteria are capable of performing a wide range of functions, including: entry and storage, transmission and receipt of care summaries, clinical decision support, patient lists and education resources, generation of public health submission data, and patient engagement tools. Entry and storage is related to the ability to enter, access and modify patient demographic information, vital signs, smoking status, medications, clinical and radiology laboratory orders and results. Transmission and receipt of care summaries involve the ability to receive, incorporate, display and transmit transition of care/referral summaries. Clinical decision support features configurable clinical decision support tools, including evidence-based support interventions, linked referential clinical decision support, and drug-drug and drug-allergy interaction checks. Patient lists and education resources include the ability to create patient lists based on problems, medications, medication allergies, demographics and laboratory test result values, and the ability to identify patient-specific education resources based on such data elements. Generating public health submission data allows users to create electronic immunization and syndromic surveillance data files that can be submitted to public health agencies. Patient engagement tools allow medical professionals to grant patients with an online means to view, download and transmit their health information to a third party, provide patients with clinical summaries after office visits, and facilitate secure-doctor patient messaging.

### Adding an Image to a Patient Medical Data Record

When a doctor takes a picture of a patient's condition (e.g., a rash) and uploads the image to a patient medical data record, conventional methods involve a multitude of time-consuming steps (e.g., saving the image to a device memory, emailing the image, downloading the image to a desktop computer, logging into an EHR system, and uploading the image to the patient medical data record.) The above steps, when performed using conventional methods, incur many HIPAA Security Rule violations regarding the storage and transmission of private health information.

### BRIEF SUMMARY

The HIPAA Security Rule introduces problems that are solved by technical solutions including minimizing transactions among devices, reducing the number of times and places that the image is stored, and transforming image data. Embodiments allow a user (e.g., a healthcare provider such as a physician or nurse) to use a computing device (e.g., a smart phone, a camera, a tablet, a personal digital assistant (PDA), or a personal computer) to capture an image and/or add an image (e.g., a photo of a rash), encrypt the image, transmit the encrypted image, decrypt the encrypted image, and insert the image directly into a patient's electronic medical record while maintaining HIPAA Security Rule compliance. In embodiments, the selection of the patient's electronic medical record may be based on a search of a user's patient list or the user's electronic appointment schedule that may be integrated into a workflow of the user's practice.

Embodiments include a computer-implemented method, a computer program product, and a system for inserting an image into a patient medical data record. Embodiments include receiving from a user a request to add or insert the image to the patient medical data record. When the request is received from an interface of the patient medical data record, for example, the patient medical data record to which the user desires to add an image, embodiments further include obtaining the image; encrypting the image; saving the encrypted image; transmitting the encrypted image from the temporary storage to the server; receiving from the server, a confirmation that the image has been added to the patient medical data record; and deleting the saved encrypted image from the temporary storage on the client device.

Further embodiments, features, and advantages, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable one of ordinary skill in the art to make and use the disclosure.

FIG. 1A illustrates an interface that presents a patient medical data record, according to an embodiment.

FIG. 1B illustrates an interface on a computing device that presents a selectable indicator for adding an image to a patient medical data record.

FIG. 2 is a diagram illustrating an example system for adding an image to a patient medical data record, according to an embodiment.

FIG. 3 is a flowchart illustrating an example method for adding an image to a patient medical data record, according to an embodiment.

FIG. 4 is a diagram illustrating an example computing device, according to an embodiment.

FIG. 5 illustrates a conventional patient medical data record interface.

FIG. 6 is a flow chart illustrating a conventional method for adding an image to a patient medical data record.

The drawing in which an element first appears is typically indicated by the leftmost digit or digits in the corresponding reference number. In the drawings, like reference numbers may indicate identical or functionally similar elements.

### DETAILED DESCRIPTION

### Overview

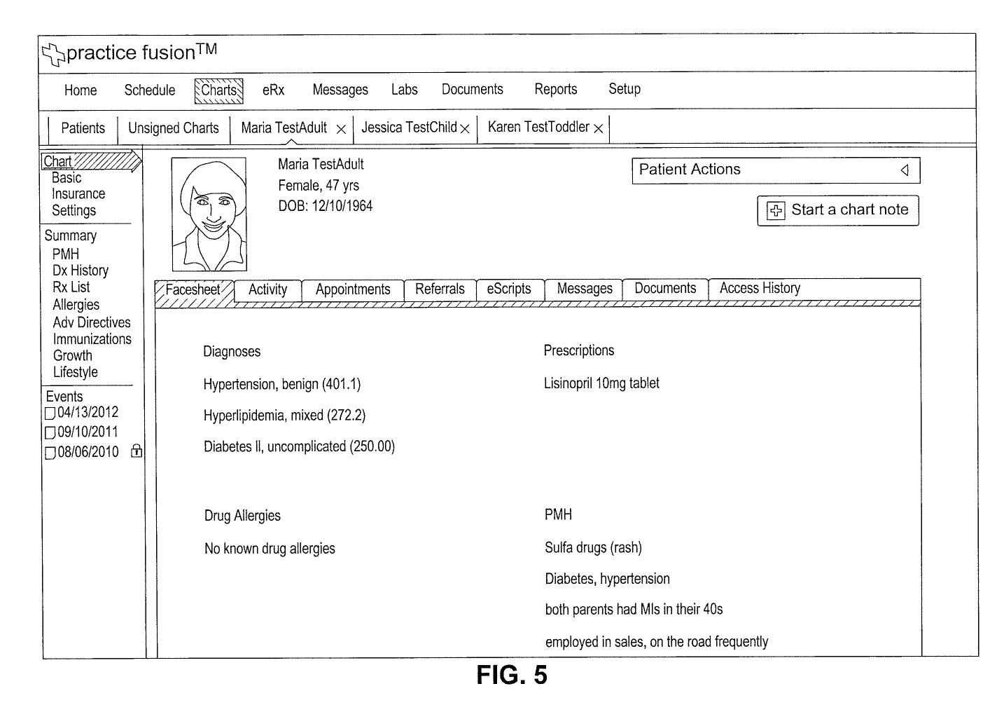

When a patient visits a healthcare provider, the healthcare provider typically reviews the patient's medical records. FIG. 5 illustrates a conventional patient medical data record interface. The patient medical data record mimics a patient chart, in that it contains various types of information about a particular patient, from basic facts to more detailed medical information. Disparate types of information may be separated into various tabs, as illustrated in FIG. 5. For example, FIG. 5 has a home screen for the patient that includes tabs for “messages” and “documents.” There is also a “Start a chart note” button that may be selected when a healthcare provider wishes to add new information into the record.

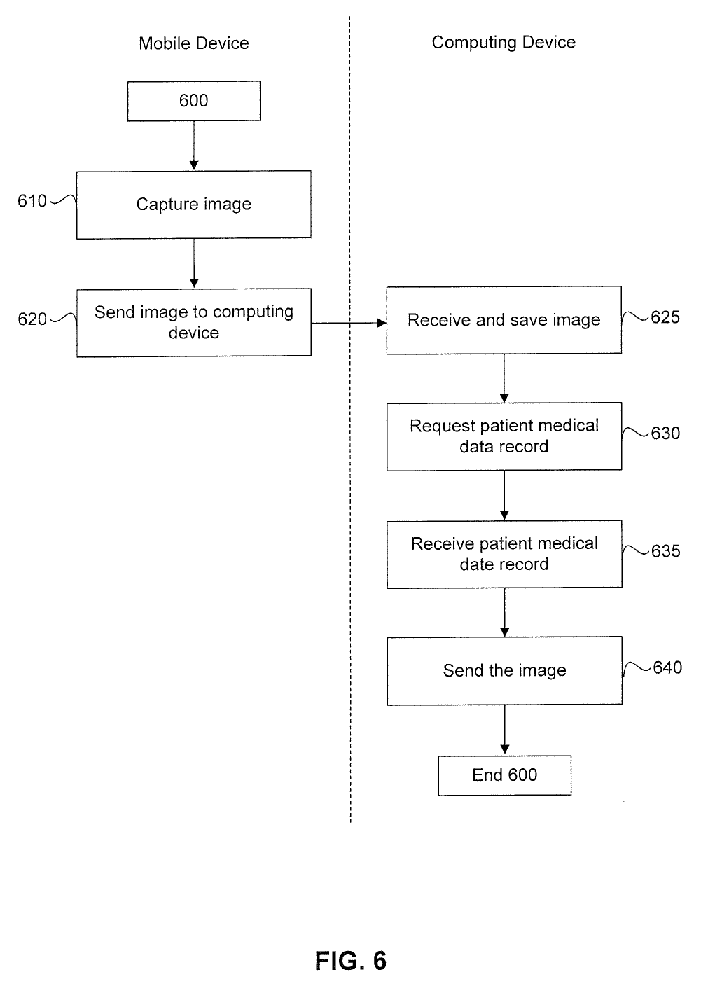

However, when the healthcare provider wants to add an image of the patient's condition to the patient medical data record, there is no simple way to do this using conventional methods. As a result, the healthcare provider often performs multiple time-consuming steps that typically incur many HIPAA Security Rule violations. FIG. 6 is a flow chart illustrating a conventional method for adding an image to a patient medical data record. In this example, the healthcare provider is the user of the EHR system.

Method 600 begins at step 610 where the user captures an image of the patient's condition with a mobile device. For example the user may take a photo of a patient's condition such as a rash using the mobile device, such as a phone or a camera. As the mobile device is likely not HIPAA compliant, this action may constitute a HIPAA violation.

At step 620, the user transfers the image to a computing device such as a desktop computer with access to an EHR system. For example, the user may attach the image to an email message and send the email message to an email account that is accessible from the desktop computer. Depending on the type of email provider used (e.g., whether it is a cloud-based email provider, and/or an unsecured email provider), this action may constitute one or multiple HIPAA violations.

At step 625, the email is opened from the desktop computer, and the user may save the attached image to the desktop computer in preparation for uploading the image into a patient medical data record, possibly constituting another HIPAA violation. Or, if a camera is used to capture the image, the user may transfer the image from the camera's memory card to the desktop computer, also potentially constituting a HIPAA violation.

At step 630, the user searches for the patient medical data record in the EHR system (e.g., the user sends via the computing device, a request for the patient medical data record to the EHR system). If the user is not already logged into the EHR system, the user first enters login credentials to gain access to the EHR system.

At step 635, the user finds the patient medical record (e.g., the computing device receives the patient medical record from the EHR system).

At step 640, the user uploads the captured image saved on the desktop computer to the patient medical data record (e.g., the computing device sends the captured image to the EHR system), possibly constituting another HIPAA violation, and method 600 ends.

The conventional method is highly time-consuming for the user, and violates many medical data privacy protection laws in the HIPAA Security Rule.

Embodiments address the problems introduced by the HIPAA Security Rule and provides a technical solution that minimizes transactions among devices, reduces the number of times and places that the image is stored, and transforms the image data. Embodiments include a method, computer program product, and system for quickly adding an image that is encrypted and transmitted. The encrypted image is decrypted and the image is inserted directly into a patient medical data record, while protecting the privacy of the patient's medical information and complying with the HIPAA Security Rule.

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to effect such feature, structure, or characteristic in connection with other embodiments whether or not explicitly described.

### Adding an Image to a Patient Medical Data Record

During a visit with a healthcare provider, the healthcare provider may review a patient medical data record, a patient's electronic medical record. The patient's electronic medical record may be visible on a computing device, which includes but is not limited to a smart phone, a tablet, a personal digital assistant (PDA), a laptop, or a desktop computer. The healthcare provider may want to capture an image of a condition (e.g., a rash) to monitor the condition's progress over time, for example. This may allow the healthcare provider to look at images from past appointment visits to determine whether a prescribed medicine is resulting in a positive outcome.

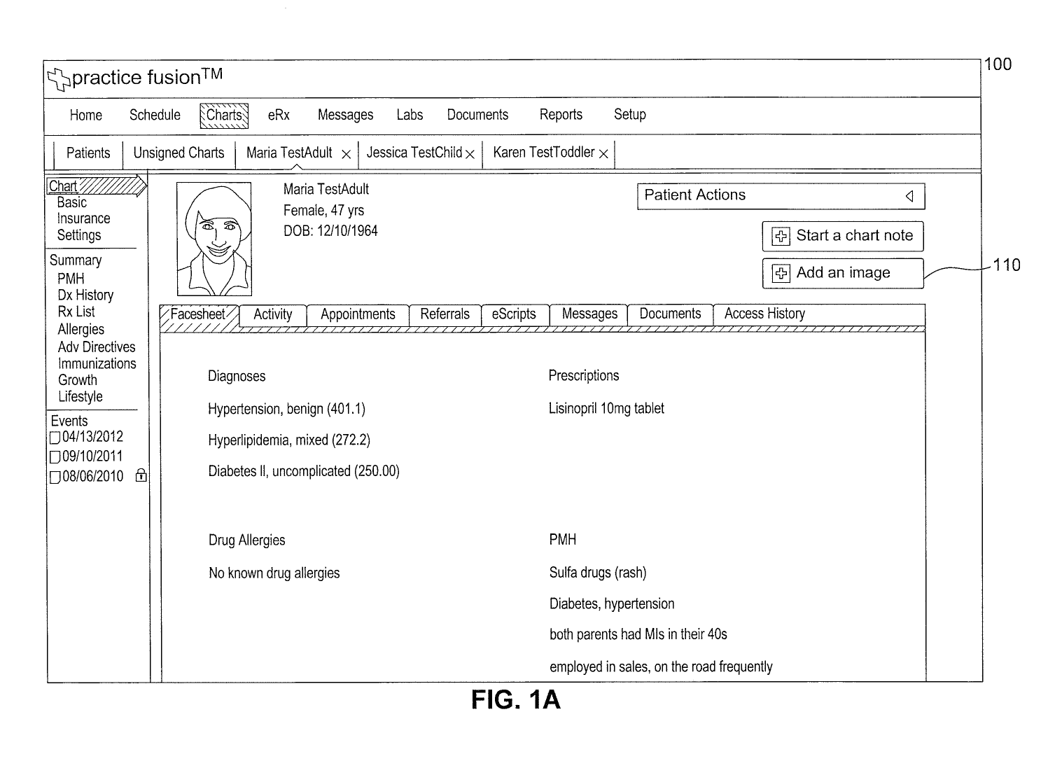

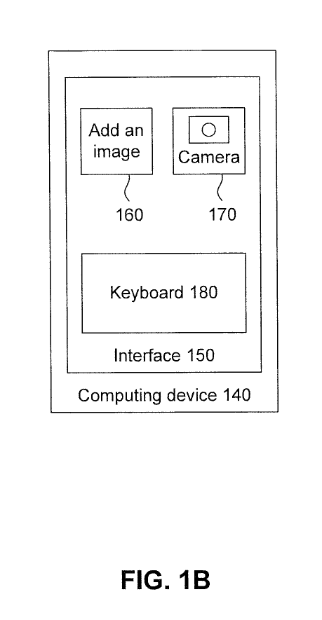

FIG. 1A illustrates an interface 100 that presents a patient medical data record, according to an embodiment. In contrast to the conventional interface shown in FIG. 5, interface 100 includes a selectable indicator 110, such as a button or link, for the healthcare provider to select from the computing device displaying the patient medical data record. Selectable indicator 110 is not limited to a particular location on a patient medical data record interface. FIG. 1B illustrates an interface 150 on computing device 140 that presents selectable indicator 160 for adding an image to an patient medical data record. Interface 150 may include other items such selectable indicator 170 for a camera. In other embodiments, selectable indicator 110 is located on an interface presenting an ERR system home page. Once the selectable indicator is selected, the EHR system may retrieve a patient medical data record based on the healthcare provider's electronic appointment schedule, or the user may search for and/or request a patient medical data record to which the image is to be added. For example, the patient medical data record may be identified based on a search of the healthcare provider's list of patients.

When the healthcare provider selects selectable indicator 110 from a patient medical data record, or selectable indicator 160, the computing device may prompt the healthcare provider to obtain the image by using a capability or combination of capabilities of the computing device. Such capabilities include but are not limited to a touchscreen, a camera/scanner, a location determiner (e.g., a Global Positioning System (GPS) determiner), a speech recognizer, a voice recorder, an augmented reality module, a gyroscope, and a gesture recognizer. In an embodiment, the healthcare provider may adjust the image using the computing device. Such adjustments include but are not limited to one or more of cropping, editing, adding a note, adding an audio note, adding a caption, and adding a location. Once obtained, the image or adjusted image is added to the patient medical data record.

In embodiments, as will be discussed in further detail below, interface 100 is simply an instantiation of an EMR on a browser or other application connected to a server, where the EMR is stored on the server (not locally). Because interface 100 is an instantiation of the EMR located on the server, rather than a local copy of the EMR, the image, when entered via the interface, is incorporated directly into the network-based EMR.

### System

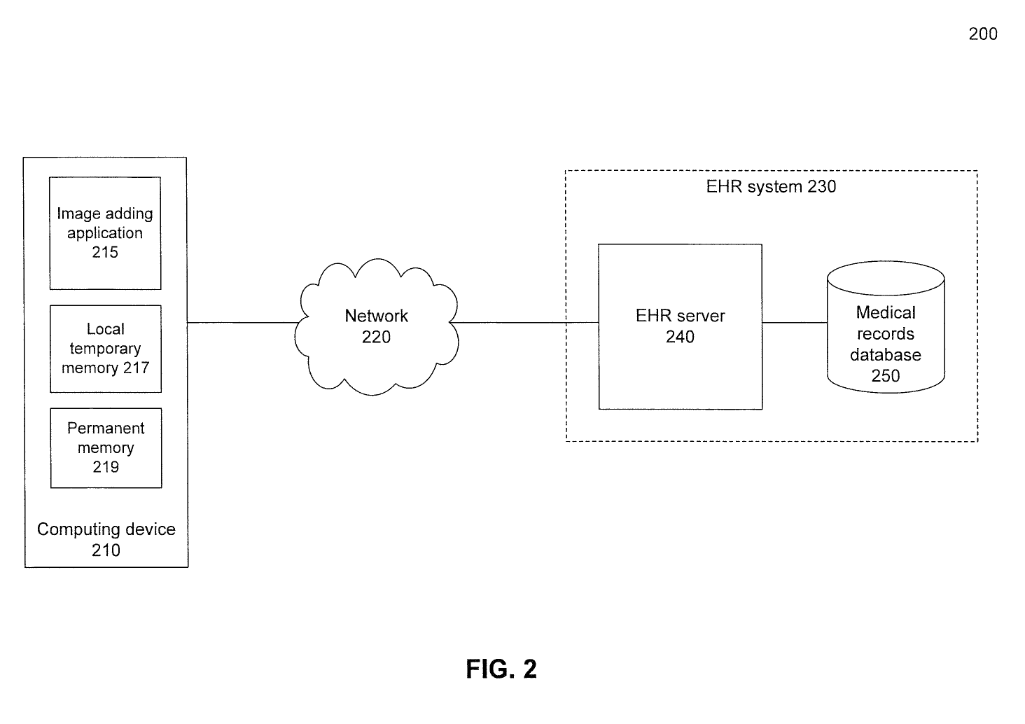

FIG. 2 is a diagram illustrating an example system 200 for adding an image to an patient medical data record, according to an embodiment. System 200 includes computing device 210 and EHR system 230 connected by one or more networks 220, such as the Internet. EHR system 230 includes at least EHS server 240 and medical records database 250.

Computing device 210 may be any type of computing device, such as and without limitation, a personal computer, a mobile phone, a tablet, a PDA, a workstation, an embedded system, a game console, a television, a set top box, or any other computing device. In an embodiment, the user may interface with computing device 210 through image adding application 215. Image adding application 215 communicates with EHR server 240 in EHR system 230. An example of establishing communications between a computing device and an EHR system is in U.S. patent application Ser. No. 14/318,492, filed on Jun. 27, 2014, entitled Physician Device Integration into Electronic Health Record System, which is incorporated herein by reference in its entirety.

Image adding application 215 may be a native application that is specific to a particular computing device platform, such as but not limited to the iOS platform produced by Apple Inc. of Cupertino, Calif., the Android platform produced by Google Inc. of Mountain View, Calif., the Windows platform produced by Microsoft Corp. of Redmond, Wash., the Blackberry platform produced by Blackberry Ltd. of Ontario, Calif., or the open-source Linux platform. In an embodiment, image adding application 215 may have access to the capabilities of the computing device that may include but not are not limited to a touchscreen, a camera/scanner, a location determiner (e.g., a GPS determiner), a speech recognizer, a voice recorder, an augmented reality module, a gyroscope, or a gesture recognizer. Once the image is obtained, the image is transmitted to EHR system 230 and inserted into the patient medical data record avoiding multiple HIPAA Security Rule violations, as will be described below. Computing device 210 may include local temporary memory 217 as well as permanent memory 219. Local temporary memory 217 may be random access memory (RAM), that may temporarily store an image that can be deleted from a user device as soon as a transaction is complete, in accordance with HIPAA Security Rule restrictions. Permanent memory 219 may be for example, a hard disk drive.

EHR system 230 includes at least EHR server 240 coupled to a medical records database 250. EHR server 240 may be implemented on one or more different computing devices having server capabilities. Such a computing device may include, but is not limited to, a device having a processor and memory, including a non-transitory memory, for executing and storing instructions. The memory may tangibly embody the data and program instructions. Software may include one or more applications and an operating system. Hardware can include, but is not limited to, a processor, memory, and graphical user interface display. The computing device may also have multiple processors and multiple shared or separate memory components. For example, the computing device may be a part of or the entirety of a clustered computing environment or server farm.

Medical records database 250 may be any type of structured data store, including a relational database.

### Method

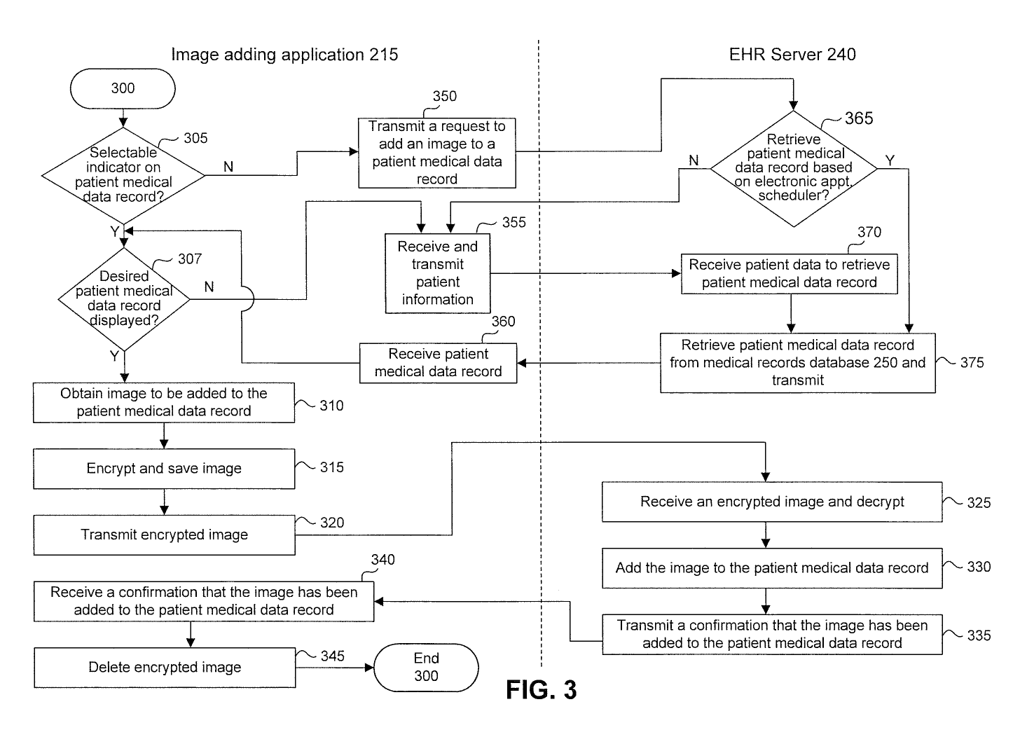

To respond to a request from a user to add an image to a patient medical data record, image adding application 215 on computing device 210 and EHR system 240 may operate as described below with respect to FIG. 3 to capture, encrypt, and insert an image into a patient medical data record to reduce the number of times and places the image is stored, thereby avoiding multiple HIPAA Security Rule violations as described in FIG. 6. FIG. 3 is a flowchart illustrating an example method 300 for adding an image to a patient medical data record, according to an embodiment. For ease of discussion and not limitation, method 300 is described with reference to elements from FIGS. 1A, 1B, 2, and 6.

Method 300 begins at step 305, when image adding application 215 receives an input from the user requesting to add an image to a patient medical data record. A determination is made whether the user selected selectable indicator 110 on a patient medical data record as shown in FIG. 1A, selectable indicator 160 as shown in FIG. 1B, or elsewhere, for example, on a home page of EHR system 230. When selectable indicator 110 is located on a patient medical data record, method 300 continues to step 307. Otherwise, method 300 proceeds to step 350.

At step 307, a determination is made regarding whether the desired patient medical data record is being displayed on the computing device 210. If no patient medical data record is being displayed, or if the displayed patient medical data record is not the desired patient medical data record, method 300 proceeds to 355.

If the desired patient medical data record is displayed, method 300 proceeds to step 310. If the desired patient medical data record is displayed among several patient medical data records, the user may select the desired patient medical data record, and method 300 proceeds to step 310.

At step 310, image adding application 215 may prompt the user to obtain an image. For example, image adding application 215 allows the user to access the capabilities of computing device 210 to obtain the image to be added to the patient medical data record. As discussed above, capabilities of computing device 210 may include but not are not limited to: a touchscreen, a camera/scanner, a location determiner, a speech recognizer, a voice recorder, an augmented reality module, a gyroscope, and a gesture recognizer. For example, when computing device 210 is a smart phone running a secure EHR application, the user may use a smart phone's capabilities, such as a touchscreen, camera, and a speech recognizer, to capture an image that includes a date, a time, a location, and a smart phone identifier. In another example, when computing device 210 is personal computer or laptop running a secure EHR application, the user may use an onboard camera and keyboard to capture the image. Capturing the image using the capabilities of computing device 210 minimizes transactions among devices, thereby avoiding one or multiple HIPAA violations such as step 620 of FIG. 6, where an image captured by a first device (e.g., a smart phone) is transmitted (e.g., emailed) to a second device (e.g., a desktop computer).

In an embodiment, the image may be a still image, a video, or a combination thereof. In another embodiment, the user may adjust the image using the one or more capabilities of computing device 210. For example, the user may adjust the image by cropping, editing, adding a note, adding an audio note, adding a caption, adding a location, adding augmented reality features to highlight particular areas of concern or a combination thereof. In an embodiment, the user may make a copy of the image that is then adjusted accordingly to allow the user to readily compare the image and the adjusted copy of the image.

Alternatively, the user may receive an unsolicited image provided by the patient, for example, as an email attachment, if the patient is not aware of or waives the HIPAA Security Rule.

At step 315, the image is encrypted and saved in local temporary memory 217. The image is saved in local temporary memory 217, such as RAM, so that the image can be deleted from the user device as soon as the transaction is complete. This avoids a HIPAA violation that may occur if the image is stored, for example, in the permanent memory 219 of the user device as described in steps 610 (e.g., permanent memory in a camera or a smart phone) and 625 (e.g., permanent memory on a desktop computer) of FIG. 6. For example, image adding application 215 transforms the image by encrypting the image and saves the encrypted image in a local temporary memory 217. In an embodiment, the encryption is a symmetric encryption. In an embodiment, the image is encrypted based on Secure Sockets Layer (SSL) encryption. Alternatively the image may be encrypted based on the user's login credentials for accessing EHR system 230. For example, a user's login credentials may include a username and a password. The username and password may be hashed to generate an encryption key. The username and/or password may also be used to generate a salt as part of the encryption key, as would be understood by one of ordinary skill in the art.

At step 320, image adding application 215 transmits the encrypted image to EHR server 240. Transmitting the encrypted image securely is an improvement that avoids a possible HIPAA violation as described in step 640 of FIG. 6.

At step 325, EHR server 240 receives and decrypts the encrypted image. For example, if the encryption was a symmetric encryption based on SSL encryption or alternatively based on the user's login credentials, EHR server 240 decrypts the encrypted image accordingly.

At step 330, EHR server 240 adds the image to the patient medical data record. The image may be added to the patient medical data record in-line or otherwise on a same document as other information in the patient medical data record for a particular patient, for example. Or, in another example, the image may be stored with other images in an image database portion of the patient medical data record.

At step 335, EHR server 240 transmits a confirmation to image adding application 215 that the image has been added to the patient medical data record.

At step 340, image adding application 215 receives the confirmation that the image has been added to the patient medical data record.

At step 345, image adding application 215 deletes the encrypted image from the local temporary memory 219 to avoid a HIPAA violation as described in steps 610 and 625 of FIG. 6, where an image is stored in permanent memory; method 300 ends.

Returning to step 305, it may be that the patient medical data record specific to the patient at issue was not displayed on the display interface, for example, when selectable indicator 110 was selected. For example, selectable indicator 110 may have been selected on a home page of EHR system 240 without identifying a specific patient, or selectable indicator 160 may have been selected from interface 150 of computing device 140 as shown in FIG. 1B. In such an instance, method 300 proceeds to step 350.

At step 350, image adding application 215 transmits a request to add an image to EHR server 240, without identifying a specific patient.

At step 365, EHR server 240 receives the request to add an image to a patient medical data record. Since no patient identification information is included in the request, a determination is made whether a patient can be identified and a patient medical data record can be retrieved based on the user's electronic appointment schedule. In an embodiment, such an indication is included in the request. When the patient medical data record can be retrieved based on the user's electronic appointment schedule, method 300 proceeds to step 375. Otherwise, method 300 proceeds to step 355.

At step 375, EHR server 240 retrieves one or more patient medical data records from medical records database 250 based on a user's appointment schedule, or retrieves the desired patient medical data record based on patient data received from the user. When the patient medical data record retrieval is based on the user's electronic appointment schedule, one or more patients may be scheduled so one or more corresponding patient medical data records may be retrieved. EHR server 240 transmits one or more patient medical data records to image adding application 215, and method 300 proceeds to step 360.

At step 360, image adding application 315 receives one or more patient medical data records from EHR server 240. Method 300 then proceeds to step 307, described above.

Turning now to step 355, at step 355 patient data is received from the user. Method 300 may arrive at step 355 for a variety of reasons. For example, the patient may be making an emergency visit without an appointment, or perhaps the patient is visiting outside of normal office hours such that no patient is listed in the user's schedule as having an appointment, or if the user's schedule is inaccessible in step 365, then patient information will need to be received at step 355. Further, if a patient medical data record previously provided by EHR server 240 in step 375 is not the desired patient medical data record, then the user will need to provide information at step 355 so that the correct patient medical data record can subsequently be retrieved.

The patient data may be received from the user in a variety of ways. In one example, the user may search for a patient using a searching capability built into EHR system 230. Image adding application 215 may receive from the user one or more of, for example and without limitation, a last name, a first name, a birth date, a social security number, an insurance policy number, an identifier that uniquely identifies the patient medical data record, etc. When image adding application 215 receives patient data from the user, method 300 proceeds to step 370. At step 370, EHR server 240 receives the patient data from image adding application 215, and method 300 proceeds to step 375, described above.

### Computing Device

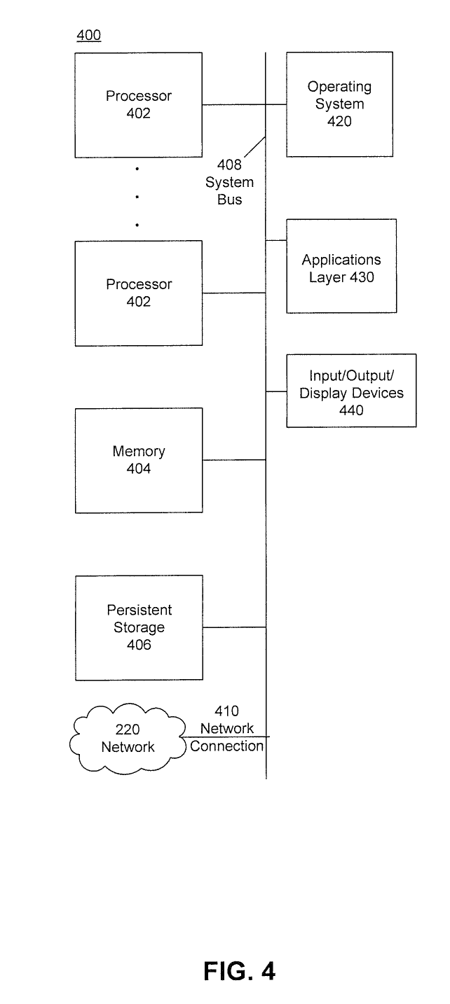

An example computing device is illustrated in FIG. 4. FIG. 4 is a diagram illustrating a computing device 400 that accesses a network 220 over a network connection 410 that provides computing device 400 with telecommunications capabilities. Computing device 400 uses an operating system 420 as software that manages hardware resources and coordinates the interface between hardware and software. Operating system 420 may include but is not limited to for example, iOS, Android, Windows, Blackberry, or Linux.

In an embodiment, computing device 400 contains a combination of hardware, software, and firmware constituent parts that allow it to run an applications layer 430. Computing device 400, in embodiments, may be organized around a system bus 408, but any type of infrastructure that allows the hardware infrastructure elements of computing device 400 to communicate with and interact with each other may also be used.

Processing tasks in the embodiment of FIG. 4 are carried out by one or more processors 402. Processor 402 may comprise suitable logic, circuitry, dedicated circuits, and/or code that may enable processing data and/or controlling operations of computer system 400. However, it should be noted that various types of processing technology may be used here, including multi-core processors, multiple processors, or distributed processors. Additional specialized processing resources such as graphics, multimedia, or mathematical processing capabilities may also be used to aid in certain processing tasks. These processing resources may be hardware, software, or an appropriate combination thereof. For example, one or more of processors 402 may be a graphics-processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

To manipulate data in accordance with embodiments describe herein, processors 402 access a memory 404 via system bus 408. Memory 404 is non-transitory memory, such as random access memory (RAM), and may include for example, local temporary memory 217 of FIG. 2. Memory 404 may include one or more levels of cache. Memory 404 has stored therein control logic (e.g., computer software) and/or data. For data that needs to be stored more permanently, processors 402 access persistent storage 404 via system bus 408. Persistent storage 406 may include, for example, a hard disk drive and/or a removable storage device or drive. Persistent storage 406 may include for example, permanent memory 219 of FIG. 2. A removable storage drive may be an optical storage device, a compact disc drive, flash memory, a floppy disk drive, a magnetic tape drive, tape backup device, and/or any other storage device/drive.

Processors 402, memory 404, and persistent storage 406 cooperate with operating system 420 to provide basic functionality for computing device 400. Operating system 420 provides support functionality for applications layer 430.

Network connection 410 enables computer device 400 to communicate and interact with any combination of remote devices, remote networks, remote entities, etc. For example, network connection 410 may allow computer device 400 to communicate with remote devices over network 404, which may be a wired and/or wireless network, and which may include any combination of LANs, WANs, the Internet, etc. Control logic and/or data may be transmitted to and from computer device 400 via network connection 410.

Computing device 400 also includes input/output/display devices 440, such as a touchscreen, a camera/scanner, a location determiner (e.g., a Global Positioning System (GPS) determiner), a speech recognizer, a voice recorder, an augmented reality module, a gyroscope, a gesture recognizer, monitors, keyboards, pointing devices, Bluetooth devices, etc.

Applications layer 430 may house various components that perform method 300 as described in FIG. 3 when computing device 400 is used as image adding application 215, or when computing device 400 is used as EHR server 240.

It should be noted that computer-readable medium embodiments may include any physical medium which is capable of encoding instructions that may subsequently by used by a processor to implement methods described herein. Example physical media may include floppy discs, optical discs (e.g. CDs, mini-CDs, DVDs, HD-DVD, Blu-ray), hard drives, punch cards, tape drives, flash memory, or memory chips. However, any other type of tangible, persistent storage that can serve in the role of providing instructions to a processor may be used to store the instructions in these embodiments.

### CONCLUSION

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for inserting an image into a patient medical data record, comprising:
receiving, into a patient medical data record interface on a client device, a request from a user to add the image to the patient medical data record;
automatically instructing, by the patient medical data record interface on the client device, an imaging device to obtain the image;
receiving the image from the imaging device;
encrypting the image;
saving the encrypted image in temporary storage on the client device;
transmitting the encrypted image from the temporary storage to a server for storage in the patient medical data record;
receiving from the server a confirmation that the image has been added to the patient medical data record; and
deleting the saved encrypted image from the temporary storage on the client device.

2. The method of claim 1, further comprising receiving the patient medical data record from the server, wherein the patient medical data record is identified based on an electronic appointment schedule of the user.

3. The method of claim 1, wherein the image is a still image or a video.

4. The method of claim 1, further comprising:
encrypting the image based on Secure Sockets Layer (SSL) encryption.

5. The method of claim 1, further comprising:
receiving, from the user, one or more inputs to adjust the image.

6. The method of claim 1, further comprising:
receiving patient data from the user;
transmitting the received patient data to the server; and
receiving the patient medical data record, wherein the patient medical data record is associated with the patient data.

7. A program storage device tangibly embodying a program of instructions executable by at least one processor to perform operations for inserting an image into a patient medical data record, comprising:
receiving, into a patient medical data record interface on a client device, a request from a user to add the image to the patient medical data record;
automatically instructing, by the patient medical data record interface on the client device, an imaging device to obtain the image;
receiving the image from the imaging device;
encrypting the image;
saving the encrypted image in temporary storage on the client device;
transmitting the encrypted image from the temporary storage to a server for storage in the patient medical data record;
receiving from the server a confirmation that the image has been added to the patient medical data record; and
deleting the saved encrypted image from the temporary storage on the client device.

8. The program storage device of claim 7 further comprising receiving the patient medical data record from the server, wherein the patient is identified based on an electronic appointment schedule of the user.

9. The program storage device of claim 7, wherein the image is a still image or a video.

10. The program storage device of claim 7, further comprising:
encrypting the image based on SSL encryption.

11. The program storage device of claim 7, further comprising:
receiving, from the user, one or more inputs to adjust the image.

12. The program storage device of claim 7, further comprising:
receiving patient data from the user;
transmitting the received patient data to the server; and
receiving the patient medical data record, wherein the patient medical data record is associated with the patient data.

13. A system for inserting an image into a patient medical data record, comprising:
one or more processors;
a memory;
the one or more processors configured to:
receive, into a patient medical data record interface on a client device, a request from a user to add the image to the patient medical data record;
automatically instruct, by the patient medical data record interface on the client device, an imaging device to obtain the image;
receive the image from the imaging device;
encrypt the image;
save the encrypted image in temporary storage on the client device;
transmit the encrypted image from the temporary storage to a server for storage in the patient medical data record;
receive from the server a confirmation that the image has been added to the patient medical data record; and
delete the saved encrypted image from the temporary storage on the client device.

14. The system of claim 13, the one or more processors further configured to receive the patient medical data record from the server, wherein the patient is identified based on an electronic appointment schedule of the user.

15. The system of claim 13, wherein the image is a still image or a video.

16. The system of claim 13, the one or more processors further configured to encrypt the image based on SSL encryption.

17. The system of claim 13, the one or more processors further configured to:
receive, from the user, one or more inputs to adjust the image.

18. The system of claim 13, the one or more processors further configured to:
receive patient data from the user;
transmit the received patient data to the server; and
receive the patient medical data record, wherein the patient medical data record is associated with the patient data.
